(19) United States
(12) Patent Application Publication
(10) Pub. No.: US 2012/0281738 A1
(43) Pub. Date: Nov. 8, 2012

(54) Method and Apparatus for Vectored Data Transmission

(75) Inventors: Axel Clausen, Munich (DE); Vladimir Oksman, Morganville, NJ (US); Heinrich Schenk, Munich (DE)

(73) Assignee: LANTIQ DEUTSCHLAND GMBH, Neubiberg (DE)

(21) Appl. No.: 13/384,834

(22) PCT Filed: Jul. 20, 2010
(86) PCT No.: PCT/EP10/04430

§ 371 Date: Jul. 25, 2012

Related U.S. Application Data
(60) Provisional application No. 61/226,829, filed on Jul. 20, 2009.

(51) Int. Cl. H04L 27/00; H04B 1/38; H04L 1/00

(52) U.S. Cl. 375/219; 375/295; 375/296

(57) ABSTRACT

In some embodiments, sequences of pilot signals on different communication channels of a communication convection are shifted with respect to each other. In other embodiments, crosstalk couplings are calculated based on intermediate vectors.

So-called vectoring or vectored data transmission is a technique for coordinated transmission or reception of data from a plurality of transmitters to a plurality of receivers via a plurality of communication connections in order to improve the transmission, for example to reduce the influence of crosstalk. Either transmitters or receivers are co-located.

For example, in DSL (digital subscriber line) transmission systems, for example VDSL (very high bit rate DSL) transmission systems, data may be transmitted from a central office (CO) or other provider equipment to a plurality of receivers located in different locations, for example in customer premises (CPE), via a plurality of communication lines. Crosstalk resulting from signals on different lines transmitted in the same direction, also referred to as far end crosstalk (FEXT), may result in a reduced data throughput. Through vectoring, signals transmitted over the plurality of communication lines from the central office or received via the plurality of communication lines in the central office may be processed jointly in order to reduce such crosstalk, which joint processing corresponds to the above-mentioned vectoring. In this respect, the reduction of crosstalk by coordinated transmission of signals is sometimes referred to as crosstalk precompensation, whereas the reduction of crosstalk through joint processing of the received signals is sometimes referred to as crosstalk cancellation. The communication connections which are processed jointly are sometimes referred to as vectored group.

Both at the initialization of communication and during communication, it may be necessary to add an additional communication connection to the vectored group, for example when an additional user of a DSL service becomes active. In such a case, it is desirable to determine the crosstalk coupling between the communication connection to be added to the vectored group and the communication connections in the vectored group. To this end, usually predefined sequences, for example sequences of pilot signals or training signals are transmitted via the communication connections, and the received signals are compared to the sent signals to determine an error signal. The crosstalk coupling between the communication connections are then determined based on these errors.

For very large systems comprising many communication connections, this determination is computationally complex, i.e. requires many individual calculation operations, and may take a considerable amount of time as long sequences may have to be used for training.

The independent claims define the invention in various aspects. The dependent claims define embodiments of the invention.

In an embodiment, an apparatus is provided, comprising: a transmitter configured to transmit data via a plurality of communication channels of a communication connection, wherein said transmitter is further configured to transmit a same sequence for vector training on each of said communication channels, wherein the sequences for at least two of said communication channels are shifted with respect to each other.

In a first aspect, the invention encompasses a transmitter configured to transmit data via a plurality of communication channels of a communication connection. The transmitter is configured to transmit a same sequence for vector training on a each of said plurality of communication channels, or at least on a second plurality within said plurality of communication channels, wherein the sequences for at least two of said communication channels are shifted with respect to each other. In an embodiment, at least one effect is to enable fast correlation calculation of errors with sequences when compared with a case where sequences are not shifted.

In an embodiment of the apparatus according to the invention in the first aspect, the transmitter is adapted to transmit sequences in a plurality of groups of communication channels and on communication channels within a group shifted with respect to each other. In this embodiment, for example, the communication channels are grouped into a plurality of groups of communication channels, wherein sequences transmitted on communication channels within a group are shifted with respect to each other. In an embodiment, said sequences have a length of n elements, wherein each of said group comprises m communication channels. In an embodiment, sequences for communication channels within a group are shifted by n/m elements with respect to each other.

An embodiment of the apparatus according to the invention in the first aspect, further comprises a receiver adapted to receive a shift magnitude. At least one effect of the foregoing apparatus enables reception of the shift magnitude to characterize a number of sequence elements by which said shifting is effected.

In an embodiment of the apparatus according to the invention in the first aspect, said transmitter is configured to transmit DSL data via the communication connections. In an embodiment, said communication channels correspond to different tones. In an embodiment, the sequences are sequences of pilot symbols.

An embodiment of the apparatus according to the invention in the first aspect further comprises at least one further transmitter configured to transmit data via a plurality of further communication channels of at least one further communication connection. In an embodiment, the at least one further transmitter is configured to transmit a same sequence for vector training on each of the further communication channels of each of said at least one further communication connection. In an embodiment, for each of said at least one further communication connections, the sequence for at least two further communication channels is shifted with respect to each other. In an embodiment, said communication connection and each of said at least one further communication connection is assigned a different sequence for vector training. In an embodiment, the sequences assigned to said communication connection and said at least one further communication connection are orthogonal to each other. In an embodiment, said sequences are based on Walsh-Hadamard sequences.

In an embodiment of the apparatus according to the invention in the first aspect, the sequence is transmitted to provide vector training for one or for at least one of the group consisting of reducing crosstalk from a joining communication connection to communication connections of a vectored group, reduce crosstalk from communication connections in a vectored group to a joining communication connection, and reduce crosstalk between communication connections of a vectored group.

In a second aspect, the invention encompasses an apparatus comprising a vectoring device configured to reduce crosstalk between a plurality of communication connections. In an embodiment, said vectoring device is configured to determine crosstalk coupling between said communication connections. Each communication connection can comprise a plurality of communication channels. In an embodiment, said vectoring device is further configured to adapt the vectoring based on a plurality of error values. For example, each error value can be indicative of a difference between a transmitted pilot signal and a received pilot signal. In an embodiment, said pilot signals are parts of a sequence of pilot signals. In an embodiment, said error values are derived from different communication channels. In an embodiment, the error values comprise one error value for each element of said sequence.

In an embodiment of the apparatus according to the invention in the second aspect, said vectoring device is configured to obtain a set of error values for a specific communication channel by interpolation. In an embodiment, said vectoring device is configured to determine a plurality of intermediate vectors, each intermediate vector being based on different ones of said plurality of error values. In an embodiment, the vectoring device is adapted to determine crosstalk couplings based on linear combinations of said intermediate vectors.

In an embodiment of the apparatus according to the invention in the second aspect, said vectoring device is configured to derive the error values from a communication connection to be added to a vectored group of communication connections. In an embodiment, the apparatus comprises a plurality of transmitters. In an embodiment, each transmitter is coupled to one of said communication connections. In an embodiment, the apparatus, in particular the vectoring device, is configured to assign a different sequence of pilot signals to each of said communication connections. In an embodiment, each of the transmitters is configured to transmit the respective assigned sequence over all communication channels of its assigned communication connections. In an embodiment, each of the transmitters is configured to transmit, in particular over all communication channels of its assigned communication connections, the respective assigned sequence with a shift between at least two sequences assigned to different communication channels of a communication connection. In an embodiment, the apparatus further comprises at least one receiver configured to receive said plurality of error signals based on said sequences.

In an embodiment of the apparatus according to the invention in the second aspect, the apparatus further comprises a plurality of receivers. In an embodiment, each receiver is coupled to one of said plurality of communication connections. In an embodiment, the apparatus is configured to receive shifted sequences of pilot signals on each of said communication connections. In an embodiment, the apparatus is configured to determine said plurality of error values based on said sequences. In an embodiment, the communication connections are DSL communication lines. In an embodiment, the communication channels are different tones.

In a third aspect, the invention encompasses a method, comprising transmitting a different sequence of pilot signals over each of a plurality of communication connections. In an embodiment, each communication connection comprises a plurality of communication channels. In an embodiment, said trans-mitting comprises transmitting the respective sequence on each communication channel of a communication connection. In an embodiment, the sequences for at least two communication channels of a communication connection are shifted with respect to each other. In an embodiment, a same shift magnitude is applied to corresponding communication channels on different communication connections.

In an embodiment of the method according to the invention in the third aspect, said transmitting comprises trans-mitting said sequences on grouped communication channels and shifting sequences for transmission on communication channels within a group with respect to each other. Thus, where communication channels on each communication connection are grouped, said transmitting comprises transmitting said sequences on communication channels within a group shifted with respect to each other. In an embodiment, said sequences have a length of n elements, each of said groups comprises m communication channels, and sequences for communication channels within a group are shifted by n/m elements with respect to each other. An embodiment of the method according to the invention in the third aspect further comprises regrouping said communication channels. An embodiment further comprises communicating a magnitude of the shift.

In a fourth aspect, the invention encompasses a method comprising obtaining a plurality of error values based on sequences of pilot signals. In an embodiment, the method comprises determining intermediate vectors, each intermediate vector being based on different ones of said error values. In an embodiment, components of each of said intermediate vectors are linear combinations of crosstalk couplings between different communication connections. In an embodiment, the method comprises determining crosstalk coupling between different communication connections based on linear combinations of said intermediate vectors. In an embodiment, the method further comprises adapting a vectoring based on said crosstalk values.

The above summary is merely intended to give a brief overview of some features of some embodiments of the present invention, and other embodiments may comprise additional and/or different features than the ones mentioned above. In particular, this summary is not construed to be limiting the scope of the present application.

### BRIEF DESCRIPTION OF THE SEVERAL VIEWS OF THE DRAWINGS

A detailed description is provide below with reference to the accompanying figures of which:

FIG. 1 shows a communication system according to an embodiment of the present invention,

FIG. 2 shows portions of a communication system according to an embodiment of the present invention,

FIG. 3 shows a flow diagram of a method according to an embodiment of the present invention,

FIG. 4 shows an explanatory diagram for illustrating some features of some embodiments of the present invention,

FIG. 5 shows a block diagram of a communication system according to an embodiment of the present invention,

FIG. 6 shows a block diagram of the communication system of FIG. 5 operated in a different transmission direction,

FIG. 7 shows a flow diagram of a method according to an embodiment of the present invention,

FIG. 8 shows a diagram for explaining some features of some embodiments,

FIG. 9 shows a further diagram for explaining some features of some embodiments,

FIG. 10 shows a diagram for illustrating some features or some embodiments of the present invention, and

FIG. 11 shows simulation results for some implementations of embodiments of the present invention.

### DETAILED DESCRIPTION OF THE INVENTION

In the following, some embodiments of the present invention will be described in detail. It is to be understood that the following description is given only for the purpose of illustration and is not to be taken in a limiting sense. The scope of the invention is not intended to be limited by the embodiments described hereinafter with reference to the accompanying drawings, but is to be intended only to be limited by the appended claims and equivalents thereof.

It is also to be understood that in the following description of embodiments any direct connection or coupling between functional blocks, devices, components, circuit elements or other physical or functional units shown in the drawings or described herein could also be implemented by an indirect connection or coupling. Furthermore, it should appreciated that functional blocks or units shown in the drawings may be implemented as separate circuits in embodiments, but may also be fully or partially implemented in a common circuit in other embodiments. It is further to be understood that any connection which is described as being wire-based in the following specification may also be implemented as a wireless communication unless noted to the contrary.

It should be noted that the drawings are provided to give an illustration of some aspects of embodiments of the present invention and therefore are to be regarded as schematic only. In particular, the elements shown in the drawings are not necessary to scale with each other, and the placement of various elements in the drawings is chosen to provide a clear understanding of the respective embodiment and is not to be construed as necessarily being a representation of the actual relative locations of the various components in implementations according to an embodiment of the invention.

The features of the various embodiments described herein may be combined with each other unless specifically noted otherwise.

The term “communication connection” as used herein is intended to refer to any kind of communication connection including wire-based communication connections and wireless communication connections.

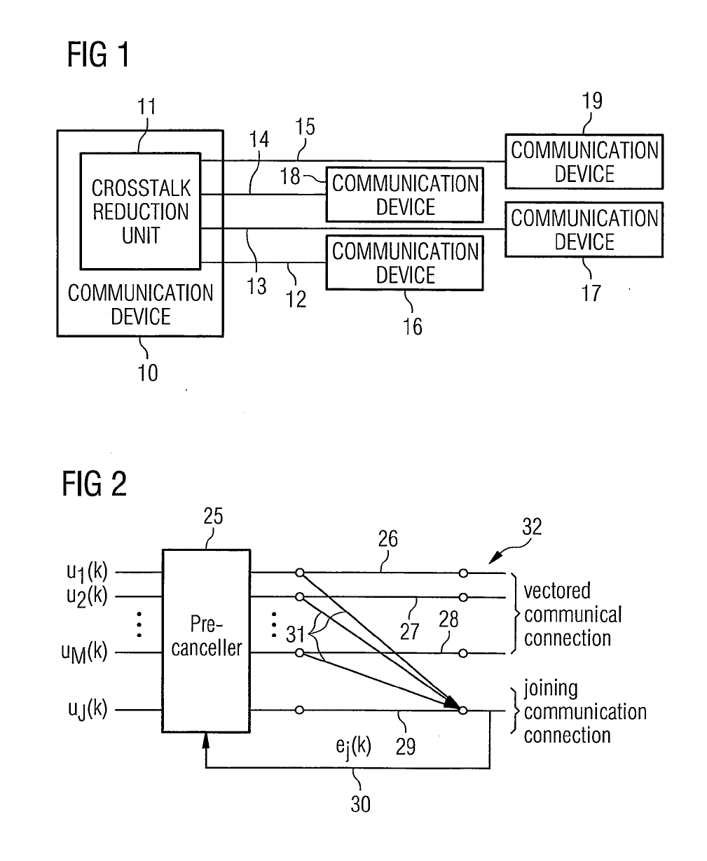

In FIG. 1, a communication system according to an embodiment of the present invention is schematically shown.

In the communication system of FIG. 1, a communication device 10 communicates with communication devices 16, 17, 18 and 19 via respective communication connections 12, 13, 14 and 15. While in FIG. 1 four communication devices 16, 17, 18 and 19 are shown, in other embodiments any suitable other number of communication devices may also be provided.

In an embodiment, the communication via communication connections 12, 13, 14 and 15 is a bidirectional communication. In such an embodiment, communication device 10 may comprise a transceiver for each of the communication connections 12, 13, 14 and 15, and each communication device 16, 17, 18 and 19 also may comprise a transceiver. In another embodiment, all or some of communication connections 12, 13, 14 and 15 may be unidirectional communication connections. In another embodiment, all or some of the communication devices 16, 17, 18, 19 might be co-located.

In the embodiment of FIG. 1, couplings between the communication connections 12-15 may cause crosstalk, for example if some or all of the communication connections are wire lines running close to each other. Through at least partial joint processing of the signals transmitted from communication device 10 to communication device 16, 17, 18 and 19 and through at least partial joint processing of signals received from communication devices 16, 17, 18 and 19 at communication device 10 in a crosstalk reduction unit 11, the influence of such crosstalk may be reduced. As already mentioned, the joint processing for crosstalk reduction is also referred to as vectoring, and the communication connections which are subjected to such a crosstalk reduction are also referred to as vectored group.

In the following, the transmission direction from communication device 10 to communication devices 16, 17, 18 and 19 will be referred to as downstream direction, and the opposite transmission direction from communication devices 16, 17, 18 and 19 to communication device 10 will be referred to as upstream direction. Reduction of crosstalk in the downstream direction is also referred to as crosstalk precompensation since the signals transmitted are modified before transmission, i.e. before the actual crosstalk occurs, whereas the reduction of crosstalk in the upstream direction is also referred to as crosstalk cancellation as here through joint processing in crosstalk reduction unit 11 the crosstalk is reduced or cancelled after it has occurred.

In embodiments, crosstalk cancellation may for example be performed by calculating received signals for each communication connection depending on a linear combination of all received signals on all communication connections of the vectored group, and crosstalk precompensation may be performed by calculating signals to be transmitted via each communication connection depending on a linear combination of signals to be transmitted on all communication connections. However, other calculation methods, for example non-linear calculations, are also possible.

In order to perform this crosstalk reduction, i.e. the vectoring, the crosstalk reduction unit 11 has to be “trained”, i.e. the crosstalk reduction unit 11 needs information regarding the actual crosstalk occurring between the communication connections in the vectored group for example in the form of coupling coefficients. This may for example be achieved by transmitting predetermined pilot signals for performing the training, which may also referred to as training signals, via the communication connections and analyzing the received signals to determine the crosstalk. It should be noted that these pilot signals may not only be transmitted during dedicated training phases, but also during regular data trainsmission. In this respect, the terms training and adapting are used synonymously herein and may be used to refer to a training for initialization purposes, for example when a communication connection joins a vectored group, a training during data transmission to account e.g. for changes in crosstalk or both. In embodiments, data transmission via the communication connections comprises the transmission of pilot signals or symbols, wherein between the pilot signals other data like payload data may be transmitted. In an embodiment, the pilot signals or modified pilot signals are used for training crosstalk reduction unit 11. In an embodiment, synchronization signals or synchronization symbols may be used as pilot signals.

In a communication system like the one shown in FIG. 1, the situation may occur that a communication connection is to be added to the vectored group. For example, in the embodiment of FIG. 1 initially only communication connections 12, 13 and 14 may be included in the vectored group, while communication connection 15 may be inactive (for example communication device 19 may be switched off) and therefore not be added to the vectored group. When communication device 19 becomes active, in order to also reduce the crosstalk between communication connection 15 and communication connections 12-14 which already are incorporated in the vectored group, communication connection 15 is to be added to the vectored group. For such an additional communication connection to be added, crosstalk reduction unit 11 has to be trained and adapted accordingly. It should be noted that also at the initialization or start-up of the system the vectored group may be “built” by adding one communication connection after the other.

In an embodiment, for adding an additional communication connection (like communication connection 15 in the above example) to a vectored group, a first vector training is performed to reduce or cancel the crosstalk resulting from the influence of the communication connection to be added, hereinafter also referred to as the joining connection, to the communication connections already in the vectored group. When this first vector training is completed, the influence of data transmitted over the joining connection on the data transmission of the connections already in the vectored group is minimized or at least reduced by an adaptation of the crosstalk reduction coefficients of the connections already in the vectored group in crosstalk reduction unit 11 of the embodiment of FIG. 1.

Some time but not necessarily immediately after this first vector training, in the currently discussed embodiment a second vector training is performed to adapt the vectoring to reduce or cancel crosstalk resulting from the influence of the communication connections of the vectored group to the joining communication connection.

In one embodiment, which may be combined with the aforementioned embodiments, but also used separately, the vector training is generally performed using modified non-payload data carrying signals like pilot symbols or pilot signals as mentioned above. For example, synchronization symbols used in a standardized communication method like VDSL to synchronize super frames may be multiplied with sequences of +1 and −1, the sequences of the different channels being chosen such that they are orthogonal to form pilot symbols. For example, Walsh-Hadamard sequences may be used as the modulation sequence.

In some embodiments, when the above-mentioned pilot signals are received via the communication connections, an error is determined representing a difference between the sent communication signals (which are known) and the received communication signals. Based on this error, the crosstalk coupling coefficients, in the following also referred to as FEXT coupling coefficients, can be determined.

This will be explained further with respect to FIG. 2, which shows a communication system according to an embodiment which is active in the downstream direction. FIG. 2 shows the situation during the above-mentioned second vector training, i.e. a training phase where the crosstalk from the communication connection already in the vectored group to the joining communication connection, i.e. the communication connection to be added to the vectored group, is reduced through crosstalk precancellation. In particular, FIG. 2 schematically shows the second vector training in the downstream direction.

In FIG. 2, communication connections 26-29 are shown, wherein communication connections 26-28 are already in the vectored group and communication connection 29 is a joining communication connection, i.e. is to be added to the vectored group. In the second vector training phase, crosstalk from communication connections 26-28 to joining communication connection 29 is to be cancelled, said crosstalk being indicated by arrows 31 in FIG. 2. To adapt a precanceller 25, pilot signals u₁(k) to u_{M}(k) and uⱼ(k) are transmitted from an upstream end where precanceller 25 is located, e.g. a central office, to a downstream end 32 of communication connections 26-29.

While three communication connections 26-28 are shown in the vectored group, they represent any arbitrary number of connections, which also may mean only a single connection, but on the other hand may also mean some ten or even some hundred connections. Generally, the number of communication connections already in the vectored group will be designated with M in the following.

The index of u₁(k) to u_{M}(k) designates the number of the vectored communication connection on which the respective pilot signal is sent and runs from 1 to M. The index j indicates the pilot signals sent on the joining communication connection. k represents a time index, i.e. first uₙ(1) is sent, then uₙ(2) is sent etc. n in this respect is selected from 1 to M and j and designates, as explained above, the communication connection.

At a downstream end of the joining communication connection 29, an error signal eⱼ(k) is calculated which indicates a difference, e.g. a sign of a difference and/or a magnitude of a difference, between the sent pilot signal uⱼ(k) and the correspondingly received signal at the downstream end. This error signal eⱼ(k) is then sent back to precanceller 25, for example via a backchannel on communication connection 29, and is used to adapt the vectoring of precanceller 25 to reduce the crosstalk indicated by arrows 31.

To achieve this, in an embodiment crosstalk coupling coefficients between the vectored communication connections and the joining communication connections are estimated. The crosstalk coupling coefficient between the n-th vectored communication connection, n ranging from 1-M, and the joining communication connection will be labeled FEXT_{n→j} in the following. Therefore, in such an embodiment M coefficients have to be estimated. Correspondingly, M error values eⱼ are needed which in an embodiment are determined by transmitting a sequence of pilot signals on each of the communication signals which has a length of at least M sequence elements.

The relationship between M consecutive error values eⱼ, corresponding pilot signals and the FEXT coupling coefficients can be expressed as follows:

$$[ \begin{matrix}{e}_{j} ( k ) \\ {e}_{j} ( k + 1 ) \\ ⋮ \\ {e}_{j} ( k + M - 1 )\end{matrix} ] = [ \begin{matrix}{u}_{1} ( k ) & {u}_{2} ( k ) & ⋯ & {u}_{M} ( k ) \\ {u}_{1} ( k + 1 ) & {u}_{2} ( k + 1 ) & ⋯ & {u}_{M} ( k + 1 ) \\ ⋮ & ⋮ & ⋱ & ⋮ \\ {u}_{1} ( k + M - 1 ) & {u}_{2} ( k + M - 1 ) & ⋯ & {u}_{M} ( k + M - 1 )\end{matrix} ] \cdot [ \begin{matrix}{FEXT}_{1 \to j} \\ {FEXT}_{2 \to j} \\ ⋮ \\ {FEXT}_{M \to j}\end{matrix} ] \qquad ( 1 )$$

The above equation (1) is essentially exact if no additive noise is present in the system. With the presence of noise, the above equation (1) is an approximation and may serve to approximately determine, i.e. estimate, the FEXT coefficients FEXT_{n→j}; n=1 . . . M.

The above equation, for simplicity of notation, may be written in vector form:

eⱼ=U·FEXT (2)

wherein eⱼ vector of equation (1) comprising the error values, U is the matrix comprising the signal values u and FEXT is the vector comprising the values FEXT_{n→j}.

By choosing the pilot signals such that U is not a singular quadratic matrix, the vector FEXT can then be estimated by

FEXT=[U]⁻¹·eⱼ (3)

wherein [ ]⁻¹ denotes the matrix inversion operation.

In the above equations, it can be seen that sequences of pilot signals u of a length M are used. It should be noted that also a length exceeding M may be used, wherein the values exceeding M may be ignored or be accommodated by using additional “virtual” lines with FEXT coupling coefficients of zero.

In an embodiment, the sequences of pilot signals for different communication connections are orthogonal to each other. This may for example be achieved by multiplying a fixed signal value, for example a fixed signal constellation, with orthogonal sequences of +1 and −1 to obtain the actually transmitted sequences. As an example, so-called Walsh-Hadamard sequences may be used as orthogonal sequences of +1 and −1.

A Walsh-Hadamard matrix of size 2n W₂ₙ, n being an integer equal to or greater than one, is defined as

$${W}_{2 \cdot n} = [ \begin{matrix}{W}_{n} & {W}_{n} \\ {W}_{n} & - {W}_{n}\end{matrix} ] \qquad ( 4 )$$

wherein, to obtain a sequence of 1 and −1 as described above, for example

W₁=[1] (5)

may be used. Starting with equation (5), Walsh-Hadamard matrixes of any desired size 2n may then be calculated recursively. For example

$$\begin{matrix}{W}_{2} = [ \begin{matrix}1 & 1 \\ 1 & - 1\end{matrix} ] & ( 6 ) \\ {W}_{4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] & ( 7 )\end{matrix}$$

The values of one row may then be used in the above-described manner to determine an orthogonal sequence for a specific communication connection. For example, in a system with all together four lines, based on equation (7) the first row, i.e. 1, 1, 1, 1, may be used as a sequence for the first communication connection, the second row, i.e. 1, −1, 1, −1, may be used as a sequence for the second communication connection, the third row, i.e. 1, 1, −1, −1, may be used for the third communication connection and the fourth row, i.e. 1, −1, −1, 1, may be used for the fourth communication connection.

The Walsh-Hadamard matrix is symmetric and orthogonal, which means that Wₙ·Wₙ is a diagonal matrix with n as diagonal elements.

When sequences of length n based on a Walsh-Hadamard matrix Wₙ, and if as pilot signals fixed, for example fixed complex, data symbols u₀ are used, equation (3) may be rewritten as

$$FEXT = {\frac{1}{{u}_{0}} [ {W}_{n} ]}^{- 1} \cdot {e}_{j} \qquad ( 8 )$$

Using the above-described properties of the Walsh-Hadamard matrix (orthogonality and symmetry) equation (8) may also be written as

$$FEXT = \frac{1}{{u}_{0}} ( \frac{1}{n} \cdot {W}_{n} ) \cdot {e}_{j} \qquad ( 9 )$$

As mentioned above, the length of the orthogonal sequence, i.e. n, in the currently discussed embodiments is greater or equal to the number of lines M involved.

As u₀, which for example may be set to the complex value of 1+j, j being the imaginary unit, is simply a constant, it will be omitted in the following explanations for simplicity of notation.

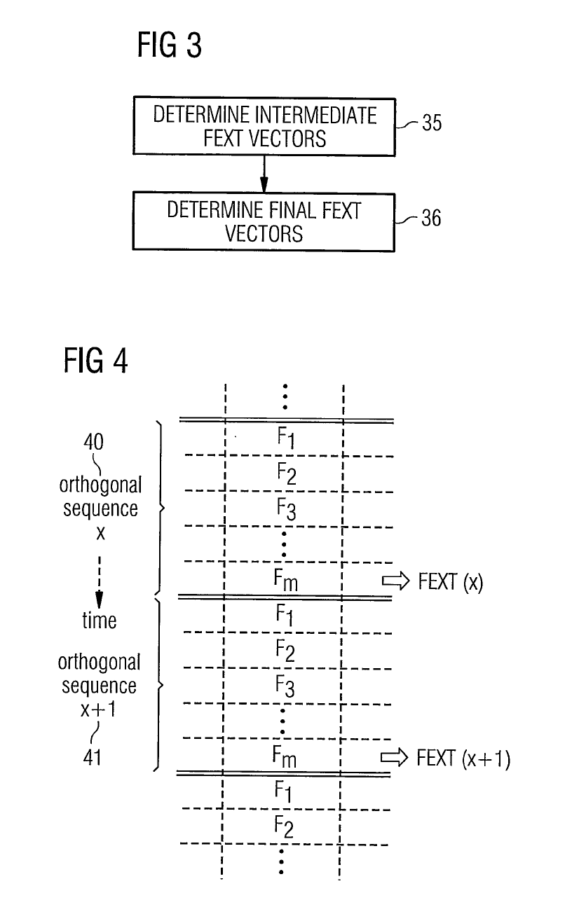

For large values of n, equation (9) requires a correspondingly large number of multiplication and addition operations for multiplying the matrix Wₙ with the vector eⱼ. In the following, some embodiments will be described where the number of such computing operations is reduced. Such an embodiment will be described with reference to FIG. 3.

Instead of directly determining the vector FEXT, i.e. the FEXT coupling coefficients, at 35 intermediate FEXT vectors are calculated. The intermediate FEXT vectors in an embodiment have a number of components less than the number of FEXT coefficients to be determined, the components of the intermediate FEXT vectors being linear combinations of components of the vector FEXT. At 36 the final FEXT vector FEXT comprising the FEXT coupling coefficients is then determined based on the intermediate FEXT vectors. An example for this procedure will be given in the following, wherein it should be noted that the embodiment of FIG. 3 is not limited to the examples given below, but the examples are merely given to illustrate the embodiment of FIG. 3 further.

In the following example, it is assumed that n=M, i.e. the Walsh-Hadamard matrix size corresponds to the number of active lines. As mentioned above, the case of n>M may simply be treated by introducing virtual lines in an embodiment. In an embodiment, n may be a power of 2, for example 2^{p}, p being a positive integer.

As an example, two intermediate FEXT vectors F₁, F₂ as follows may be used:

$$\begin{matrix}{F}_{1} = [ \begin{matrix}{FEXT}_{1 \to j} + {FEXT}_{\frac{n}{2} + 1 \to j} \\ {FEXT}_{2 \to j} + {FEXT}_{\frac{n}{2} + 2 \to j} \\ ⋮ \\ {FEXT}_{\frac{n}{2} \to j} + {FEXT}_{n \to j}\end{matrix} ] & ( 10 ) \\ {F}_{2} = [ \begin{matrix}{FEXT}_{1 \to j} - {FEXT}_{\frac{n}{2} + 1 \to j} \\ {FEXT}_{2 \to j} - {FEXT}_{\frac{n}{2} + 2 \to j} \\ ⋮ \\ {FEXT}_{\frac{n}{2} \to j} - {FEXT}_{n \to j}\end{matrix} ] & ( 11 )\end{matrix}$$

As can be seen, the intermediate vector F₁ has as components sums of the components of the vector FEXT, and the vector F₂ differences of components of FEXT as components. The length of each of the two intermediate vectors F₁, F₂, i.e. the number of components, is half the number of components of the vector FEXT.

After determining the error values, i.e. the error value eⱼ, as described above, F₁ and F₂ may be determined according to:

$$\begin{matrix}{F}_{1} = ( \frac{2}{n} \cdot {W}_{\frac{n}{2}} ) \cdot [ \begin{matrix}{e}_{j} ( k ) \\ {e}_{j} ( k + 1 ) \\ {e}_{j} ( k + \frac{n}{2} - 1 )\end{matrix} ] = ( \frac{2}{n} \cdot {W}_{\frac{n}{2}} ) \cdot {e}_{1} & ( 12 ) \\ {F}_{2} = ( \frac{2}{n} \cdot {W}_{\frac{n}{2}} ) \cdot [ \begin{matrix}{e}_{j} ( k + \frac{n}{2} ) \\ {e}_{j} ( k + \frac{n}{2} + 1 ) \\ {e}_{j} ( k + n - 1 )\end{matrix} ] = ( \frac{2}{n} \cdot {W}_{\frac{n}{2}} ) \cdot {e}_{2} & ( 13 )\end{matrix}$$

In the above equations (12) and (13), e₁ represents the first half, i.e. the first n/2 components of the vector eⱼ, and e₂ represents the second half of components. As can be seen from equations (12) and (13), only the matrix Wₙ/2, i.e. the first quarter of the original (n·n) Walsh-Hadamard matrix is used (see equation (4)).

The FEXT coupling coefficients FEXT may then be determined according to

$$\begin{matrix}[ \begin{matrix}{FEXT}_{1 \to j} \\ {FEXT}_{2 \to j} \\ ⋮ \\ {FEXT}_{\frac{n}{2} \to j}\end{matrix} ] = \frac{1}{2} \cdot ( {F}_{1} + {F}_{2} ) = \frac{1}{n} \cdot {W}_{\frac{n}{2}} \cdot ( {e}_{1} + {e}_{2} ) & ( 14 ) \\ [ \begin{matrix}{FEXT}_{\frac{n}{2} + 1 \to j} \\ {FEXT}_{\frac{n}{2} + 2 \to j} \\ ⋮ \\ {FEXT}_{n \to j}\end{matrix} ] = \frac{1}{2} \cdot ( {F}_{1} - {F}_{2} ) = \frac{1}{n} \cdot {W}_{\frac{n}{2}} \cdot ( {e}_{1} - {e}_{2} ) , & ( 15 )\end{matrix}$$

wherein with equation (14) the first half of the components of the vector FEXT are determined and with equation (15) the second half of the components are determined. By using the calculation according to equations (12)-(15), the number of arithmetic operations may be reduced compared to equation (9).

It should be noted that the usage of two intermediate vectors F₁ and F₂ is only an example. In other embodiments, generally m intermediate vectors can be used, wherein m may be a power of 2, i.e. m=2^{x} with x being an integer number, and m<n (n being the size of the Walsh-Hadamard matrix which may be equal to or greater than M, i.e. the number of lines in the vectored group, as explained above).

Each of such m intermediate vectors may be determined by using m of the total n error value described above, i.e. F₁ may be determined by using the first n/m error values, F₂ may be determined by using the second n/m error values, etc, according to:

$$\begin{matrix}{F}_{1} = \frac{m}{n} \cdot {W}_{\frac{n}{m}} \cdot {e}_{j , 1} & ( 16 ) \\ {F}_{2} = \frac{m}{n} \cdot {W}_{\frac{n}{m}} \cdot {e}_{j , 2} \\ ⋮ & ( 17 ) \\ {F}_{m} = \frac{m}{n} \cdot {W}_{\frac{n}{m}} \cdot {e}_{j , m} & ( 18 )\end{matrix}$$

In equations (16)-(18), e_{j,1} contains the first n/m values of the vector eⱼ, e_{j,2} contains the second n/m values of the vector eⱼ etc. until e_{j,m} contains the last n/m values of the vector eⱼ.

As can be seen, for the above calculations only a Walsh-Hadamard matrix of size (n/m)·(n/m) needs to be used instead of the full n·n Walsh-Hadamard matrix.

The values of the vector FEXT may then again be calculated by linear combinations of the intermediate vectors, in the above example according to:

$$\begin{matrix}[ \begin{matrix}{FEXT}_{1 \to j} \\ {FEXT}_{2 \to j} \\ ⋮ \\ {FEXT}_{\frac{n}{m} \to j}\end{matrix} ] = \frac{1}{m} ( {F}_{1} + {F}_{2} + ⋯ + {F}_{m} ) & ( 19 ) \\ [ \begin{matrix}{FEXT}_{\frac{n}{m} + 1 \to j} \\ {FEXT}_{\frac{n}{m} + 2 \to j} \\ ⋮ \\ {FEXT}_{2 \frac{n}{m} \to j}\end{matrix} ] = \frac{1}{m} ( {F}_{1} - {F}_{2} + ⋯ - {F}_{m} ) & ( 20 )\end{matrix}$$

The signs in the linear combinations of the intermediate vectors F in equations (19) and (20) in this embodiment are given according to the signs in the rows (or columns) of a Walsh-Hadamard matrix Wₘ. For example, if m=4, according to equation (7) for determining the first n/4 components of the vector FEXT only + would be used as sign, for the second n/m component +, −, +, − would be used as signs, for the third n/m component +, +, −, − would be used as signs, and for the fourth n/4 components +, −, −, + would be used as signs.

It should be noted that the above calculations only serve as an example. For example, while Walsh-Hadamard matrixes may be used for determining orthogonal sequences and also for determining the signs of the linear combinations of the intermediate vectors as explained above, other orthogonal or non-orthogonal sequences of pilot signals may be used, and the signs may then be adapted accordingly.

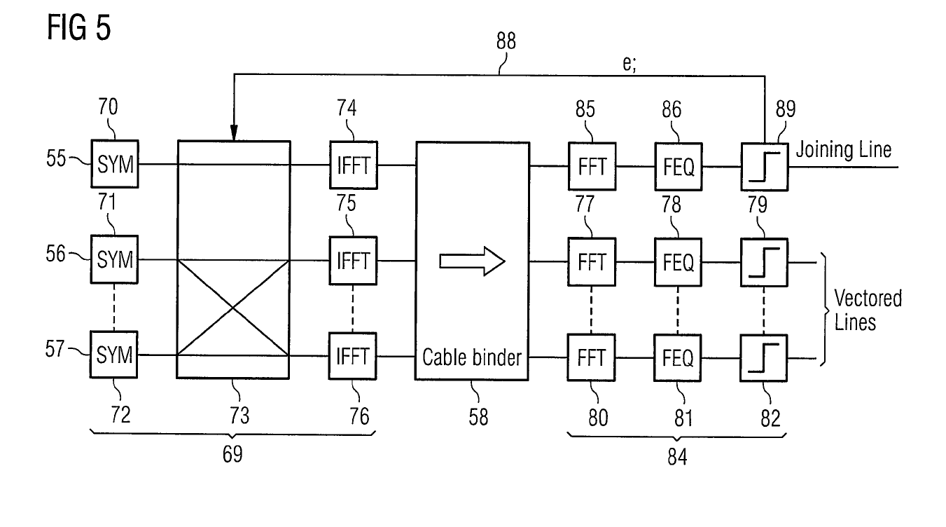

The vectors F may be determined sequentially in an embodiment according to the availability of the respective components of eⱼ which, as can be seen from equation (1), become available one after the other. This is schematically shown in FIG. 4.

In FIG. 4, in the course of a first orthogonal sequence labeled x the vectors F₁ to Fₘ are determined sequentially, and as soon as all these vectors are available the corresponding vector FEXT based on the sequence x, in FIG. 4 labeled FEXT(x) is determined. After that, the orthogonal sequence is repeated (labeled 41 in FIG. 4), i.e. after sequence×sequence x+1 follows, and the procedure is repeated. In other words, the vector FEXT may be determined several times to increase accuracy. For example, with each determination of the vector FEXT coefficients C_{→j} for precompensating crosstalk from lines in the vectored group to a joining line may be adapted according to

C_{→j}(new)=C_{→j}(old)−g·FEXT (21)

g is a step size, which for the first iteration, i.e. the first determined vector FEXT, may be set to 1 and then may be reduced for each iteration.

With some of the above-described embodiments, the computational complexity required for calculating FEXT coupling coefficients may be reduced. With some other embodiments which will be explained in the following in more detail, a FEXT vector may already estimated before the completion of an orthogonal sequence. These embodiments may be used in combination with the afore-described embodiments, but the different embodiments may also be used independently from each other.

In particular, in the following embodiments will be described where on each communication connection several communication channels are used for transmitting data. As an example, in DSL systems on each communication line data is transmitted via a plurality of carriers, i.e. frequencies, these carriers also being referred to as tones and being examples for communication channels on a single communication connection. In some of the embodiments described below, each communication channel on a communication connection essentially uses the same orthogonal sequence, but the orthogonal sequences in different channels are shifted with respect to each other.

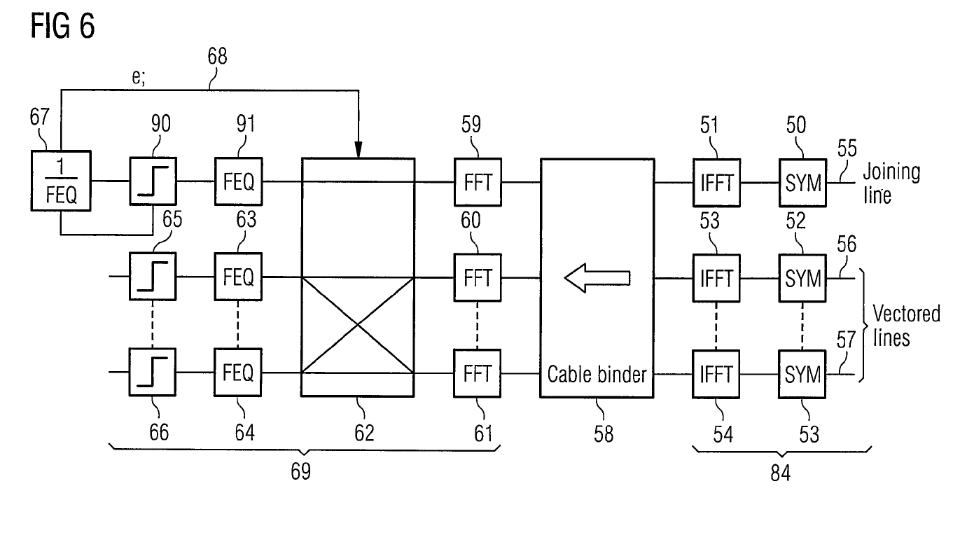

Such an embodiment may for example be implemented in a DSL system. An example for the implementation of such a DSL system will now be given referring to FIGS. 5 and 6, FIG. 5 showing a DSL communication system in the downstream direction, while FIG. 6 shows a DSL communication system in the upstream direction.

In FIG. 5, a DSL communication system according to an embodiment of the present invention is shown transmitting data in the downstream direction. In the system shown in FIG. 5, data is transmitted from a central office 69 via a plurality of communication lines 55, 56, 57 to a plurality of receivers in customer premises generally labeled 84. In the system of FIG. 5, the communication lines are joined in a so-called cable binder 58. Communication lines in a cable binder are usually located comparatively close to each other and are therefore prone to crosstalk. In the system shown in FIG. 5, communication lines 56 and 57 as well as further (not shown) communication line indicated by dotted lines are already incorporated in the vectored group. It should be noted that the number of communication lines in a vectored group is not limited to any particular number. Communication line 55 in the example shown is a joining line, i.e. is to be added to the vectored group.

In the system of FIG. 4, symbol mappers denoted with reference numerals 70, 71 and 72 map data, e.g. payload or training or pilot data, onto carrier constellations which are to be transmitted via communication lines 55, 56 and 57, respectively. A crosstalk precompensator 73 modifies these symbol mappings in order to precompensate crosstalk occurring during the transmission. The such modified carrier mappings are modulated onto a plurality of carriers for each communication line, said carriers having different frequencies and being an example for a plurality of communication channels on a single communication connection, and are then transferred into signals in the time domain by inverse fast Fourier transformations 74, 75 and 76, respectively. This type of modulation, also referred to as discrete multi tone modulation (DMT) is commonly used in DSL systems like VDSL systems or VDSL2 systems. The such generated signals are then transmitted via the communication line to the customer premises. The received signals are then converted into the frequency domain by fast Fourier transformers 77, 80 and 85, respectively and equalized by frequency equalizers 78, 81 and 86, respectively before slicers 79, 82 and 89, respectively output received constellations which, in case of an error-free transmission, correspond to input constellations generated in 70, 71, 72 originally intended for transmission. It is to be understood that for clarity's sake only some elements of the communication devices involved are shown, and further devices like amplifiers, sampling units and the like may be present.

In a vector training shown in FIG. 5, crosstalk from the lines already in the vectored group like lines 56 and 57 to the joining line is to be reduced. In another phase, for example a previous phase, the crosstalk from the joining line to the lines already in the vectored group may be reduced.

As already mentioned, for adapting the vectoring which is implemented in this case by crosstalk precompensator 73 to the joining line, synchronization symbols transmitted are modified to form orthogonal pilot sequences. The synchronization symbols on all the lines are sent in a synchronized manner, i.e. at the same time.

In an embodiment, a specific sequence is reserved for joining lines. For example, using the Walsh-Hadamard sequences described above multiplying the synchronization symbols with sequences of +1 and −1 described above, a sequence consisting only of +1 values or of alternating +1 and −1 values may be reserved for joining lines.

Via a respective backchannel in the joining line, an error signal eⱼ is transmitted back to crosstalk precompensator 73. Error signal eⱼ as described above for the synchronization symbols is indicative of a difference between the synchronization symbols sent (which are known to the receiver since fixed sequences are used) and the symbols actually received. Based on this error signal, the crosstalk precompensator 73 is adapted to reduce the error, i.e. the difference between symbols sent and symbols received, by reducing the effect of crosstalk from the joining line to the vectored line, for example corresponding to any of the embodiments described above, i.e. either using intermediate vectors or directly calculating the FEXT couplings, or also based on embodiments described below in more detail.

The corresponding system in the upstream direction is shown in FIG. 6.

In FIG. 6, some of the components for data transfer in upstream direction of the communication system already discussed with reference to FIG. 5 are shown. On the side of customer premises equipment 84, symbols 50, 52 and 53 are transmitted via the lines, symbol 50 being transmitted via the joining line 55 and symbols 52 and 53 being transmitted via the vectored lines 56, 57. Again it should be noted that while only two vectored lines are depicted, they are intended to represent any arbitrary number of vectored lines. The symbols are modulated onto a plurality of carriers for each line corresponding to the already mentioned DMT modulation according to the VDSL2 standard used and transferred into time domain signals by inverse fast Fourier transformers 51, 53 and 54, respectively. The signals are then transmitted in the upstream direction via the respective lines 55, 56 and 57 which are in cable binder 58 to central office 59. Here, the received signals are sampled and transferred to the frequency domain via fast Fourier transformers 59, 60 and 61.

A crosstalk canceller 62 is used to cancel crosstalk occurring between the lines in cable binder 58. It should be noted that crosstalk canceller 62 may fully or partially be implemented using the same circuit elements as crosstalk precompensator 73, for example by using a common digital signal processor, but also may be implemented using separate elements. Similar to what has already been described for the receiver part of customer premises equipment 84 with reference to FIG. 5, in the receiver part of central office 59 shown in FIG. 6 frequency equalizers 63, 64, 91 followed by slicers 65, 66, 90 are provided to recover received symbols which in case of error free transmission correspond to symbols 52, 53, 50 originally sent.

Also FIG. 6 shows the situation where the crosstalk from the vectored lines to the joining lines is to be reduced. In this case, an error signal eⱼ is determined based on the received symbols in the joining line, for example by slicer 90, wherein with an element 67 (which is not a mandatory element) the frequency equalization performed in element 91 is reversed. Based on the error signal eⱼ, the vectoring of crosstalk canceller 62 may then be adapted to cancel crosstalk from the lines of the vectored group to the joining lines, for example as already described above with reference to FIGS. 1-4.

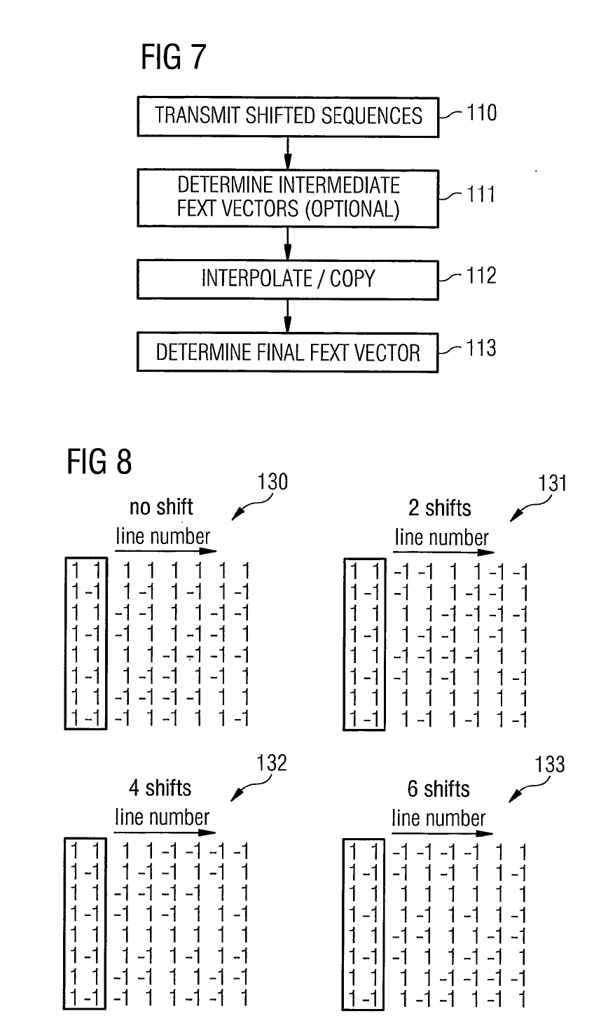

As already mentioned, in some embodiments where a plurality of communication channels is used for each communication connection, for example a plurality of carriers on each communication line in the embodiments of FIGS. 5-6, in some embodiments sequences of pilot signals usable for vector training or adaptation, also referred to as training sequences hereinafter, are transmitted in a shifted manner for different carriers (tones). In other words, the start of the sequence assigned to a specific communication connection is shifted from one tone to the other. Such embodiments will now be explained in more detail with reference to FIGS. 7-10.

In FIG. 7, a flow diagram of a method according to an embodiment is shown. The method of FIG. 7 may for example be implemented in the system of FIGS. 5 and 6, but is not limited thereto, but may be generally employed in systems where a plurality of communication channels is used on each of a plurality of communication connections.

At 110, training sequences are transmitted which, as explained above, are shifted with respect to each other for different communication channels, for example different carriers or tones. This concept of shifting will now be explained using an example with reference to FIG. 8. As an example, Walsh-Hadamard sequences having a length of 8 are used in FIG. 8. FIG. 8 at a portion 130 shows the unshifted sequences. Each sequence is a column in FIG. 8, and as indicated by an arrow the sequences for different lines are adjacent to each other. At 131, the sequences are shown cyclically shifted by two elements.

At 132, the sequences are shown shifted by 4 elements, and at 133, the sequences are shifted by 6 elements. It should be noted that the shifted orthogonal sequences are still orthogonal to each other. In all cases, the first two sequences remain the same (the first sequence consists only of one which stays the same no matter how it is shifted, and the second sequence consists of alternating 1-1 which remains the same when shifted by 2, 4 or 6 elements).

Using the sequences of FIG. 8, for example a first channel may use the non-shifted sequences of 130, a second channel may use the sequences of 131, a third channel the sequences of 132, a fourth channel the sequences of 133, a fifth channel again the sequences of 130, etc. In other words, in an embodiment using the example of FIG. 8, communication channels like carriers or tones may be grouped into groups of four communication channels, wherein each of the communication channels within a group uses a different one of the sequences of 130-133. It should be noted that as evident from FIG. 8, in such an embodiment each communication connection, for example each line, still uses its specific sequence on all its communication channels, wherein this sequence is shifted for some of the channels.

In general, m communication channels may be assigned to a group, in which case for a length of the orthogonal sequence of n, the sequences may be shifted by n/m elements. For example, with the sequences shown in FIG. 8 m=4 and n=8, and the sequences are shifted by 2 elements from 130 to 131, from 131 to 132 and from 132 to 133. Using the Walsh-Hadamard sequence discussed so far, in such a case regardless of the “shifting” the first n/m sequences remain the same. In embodiments, m=4 or m=8 is selected, but other values are equally possible.

For example, in another embodiment, a system may comprise 250 lines, such that n=256 is chosen. m in such a system may be 8, and in such a case a shift by n/m=32 elements may be used from one communication channel to the next within a group. In such a system, the sequences for the first 32 communication connections, for example the first 32 lines, are unchanged.

It should be noted that while in the currently discussed embodiments the sequences are shifted by n/m elements, in other embodiments other shifts, for example also shifts by odd numbers, are possible.

In other words, for systems as described above, for the first n/m lines no shifting is needed, such that the shifting needs only to be employed when the number of active lines in the system exceeds n/m.

At 111, optionally intermediate FEXT vectors F already explained with reference to FIGS. 1-4 are determined.

At 112, in order to be able to determine a FEXT vector, i.e. FEXT coupling coefficients, for a particular communication channel, either intermediate FEXT vectors or error values from other communication channels are copied or used for an interpolation. At 113, the final FEXT vector, i.e. the FEXT coupling coefficients, are determined using the result of 112 and optionally 111.

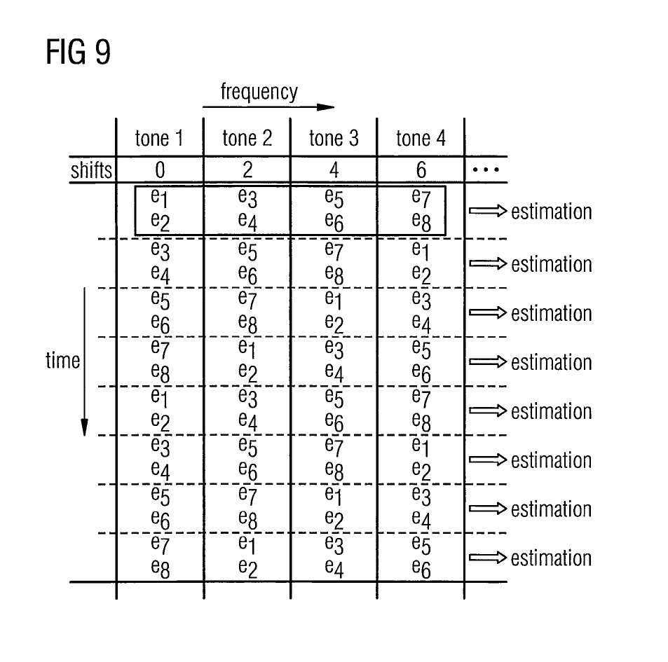

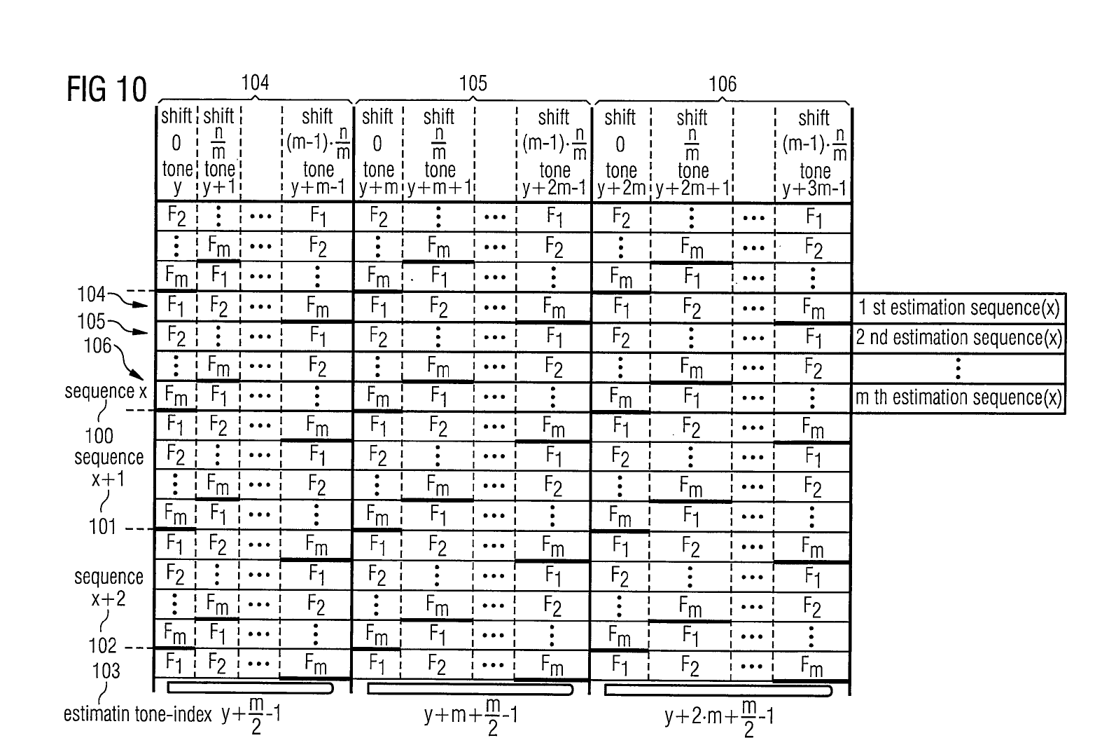

111-113 will now be further explained using simple examples with reference to FIGS. 9 and 10. FIG. 9 is used for explaining a situation where 111 is not used, whereas FIG. 10 is used for explaining a situation where 111 is used. These examples are intended to illustrate some aspects of the embodiment of FIG. 7 and are not to be construed as limiting.

In FIG. 9, corresponding to the example in FIG. 8, a sequence length n=8 is assumed for illustration purposes. However, it is to be emphasized that other sequence lengths are equally possible. Moreover, again corresponding to FIG. 8, groups of four carriers or tones are used in the example of FIG. 9, corresponding to the columns labeled tone 1 to tone 4 in FIG. 9. For tone 1, a shift of 0 is applied corresponding to group 130 of FIG. 8, for tone 2 a shift of 2 elements corresponding to group 131 of FIG. 8 is applied, for tone 3 a shift of 4 elements corresponding to group 132 of FIG. 8 is applied, and for tone 4 a shift of 6 elements corresponding to group 133 is applied.

In FIG. 9, with e₁ the error signal based on the first element of the sequence is denoted, with e₂ the error based on the second element of the sequence etc. until e₈ which denotes an error based on the 8^{th} and last element of the sequence. For example, e₁-e₈ may correspond to eⱼ(1) to eⱼ(8) of equation (1).

In a vertical direction in FIG. 9 as also indicated by an arrow the time is schematically shown. In a first time step, on tone 1 error signal e₁ pertaining to the first signals of the pilot signal sequences is obtained, after that on tone 1 signal e₂ is obtained etc. On tone 2, since here the sequences are shifted by 2 elements, first e₃ is obtained, then e₄ etc. On tone 3, corresponding to a shift of 4 elements, first e₅ is obtained, then e₆ is obtained etc. Finally, on tone 4 corresponding to a shift of 6 elements first e₇ is obtained, then e₈ is obtained etc.

As explained previously, for determining all FEXT couplings, for example in the form of the vector FEXT, a complete set of 8 error values, one for each element of the sequence, is required. In an embodiment, after the second time step, as can be seen in the example of FIG. 9 on tones 1-4 all together all 8 error values are present albeit for different tones. In an embodiment, an estimation of the FEXT vector is made based on these 8 error vector values. In such embodiments, it is used that for tones or carriers having adjacent frequencies, the crosstalk is often similar. As can be seen in FIG. 9, after a further two times step a further estimation can be made, etc.

In the example of FIG. 9, 8 error values of a group consisting of tone 1 to tone 4 are used for the estimation. In systems with a plurality of tones, as explained above, a plurality of such groups of m tones, 4 tones in the example of FIG. 9 are used. In such embodiments, instead of simply using the error value from the corresponding group (referred to as copy in 112 of FIG. 7), also an interpolation may be carried out. For example, in an embodiment for determining a value to be used for e₃ in the example of FIG. 9 for the estimation of tone 1, an interpolation between tone 2 shown and a tone 2 of a group of tones preceding the group shown (for example a group of 4 tones with lower frequencies than the one shown).

It should be noted that as shown in FIG. 9, this estimation after each two time steps can continue and for example be used to further adjust coupling coefficients for example based on equation (21). In other embodiments, this kind of estimation may be terminated after a predetermined time and be replaced by an estimation every eight time steps based only on error values for the specific tone.

As in FIG. 8, the specific values m=4 and n=8 in FIG. 9 serve only as an example for explaining some principles employed in some embodiments of the present invention, and other values may be used as well.

In the example of FIG. 9, no intermediate FEXT vectors are used, and the FEXT couplings are calculated directly based on the error values e. In another example, for example an embodiment using 111 of FIG. 7, intermediate vectors F as explained with respect to FIGS. 1-4 are used. This will be explained using a diagram example shown in FIG. 10.

In the example of FIG. 10, m tones are provided in each group, wherein m may be equal to 4 as in FIGS. 8 and 9, may be equal to 8 or may assume any other suitable number, for example a power of 2. The sequence length in FIG. 10 generally is n, and the shift between two adjacent tones in group is n/m. In FIG. 10, three groups 104, 105, 106 are shown, but it is to be noted that the number of tones is not particularly limited. The first tone in each group is assigned a shift of 0, the second tone in each group a shift of n/m etc. until the last tone in each group which is assigned a shift of (n−1)·n/m.

In the example of FIG. 10, in the first group 104 tones y to y+m−1 are grouped, in the second group tones y+m until tone y+2m−1 etc. In a line 103 a so-called “estimation tone index” is given which corresponds to a center tone in each of the groups.

Training sequences, i.e. sequences of pilot signals usable for vector training or adaptation, for example based on orthogonal Walsh-Hadamard sequences, are used as explained previously, of which three consecutive sequences 100 (sequence x), 101 (sequence x+1) and 102 (sequence x+2) are shown. The number of three sequences shown again serve merely as an example, and any desired number of sequences starting from a single sequence may be used.

At a beginning portion 104 of sequence 100, on tones y, y+m, y+2m etc., i.e. the first tone in each group, error values corresponding to the first n/m sequence elements are determined, on the second tone in each group error values pertaining to the second n/m sequence elements are determined etc. For example, for n=8 and m=2 as can be seen from FIG. 9 in 104 e₁ and e₂ would be determined for tone y, e₃ and e₄ would be determined for tone y+1 etc.

Based on these error values, intermediate vectors F₁ to Fₘ are determined after n/m time steps, i.e. after the portion 104 of sequence x. This determination may be made for example based on equations (16) to (18), the vector e_{j,1} corresponding to the vector of the n/m error values determined for tone y, the vector e_{j,2} corresponding to the n/m error values determined for tone y+1 etc.

After portion 104 of sequence× has passed, vectors F₁ to Fₘ are determined for each of groups 104-106, albeit for different tones. Similar to what was explained for FIG. 9, based on these m vectors F a first estimation of the vector FEXT, i.e. of the FEXT couplings, may be made based on equations (19) and (20). In this case, basically the values F are “copied” from the other tones to a specific tone of a group. In other embodiments, an interpolation may be performed. For example, to determine an F₂ for estimating FEXT couplings for tone y+m, an interpolation may be made between F₂ determined for tone y+m+1 and F₂ determined for tone y+1. More complex interpolations using more values, for example additionally the value for tone y+2 m+1 in the above example, are equally possible.

After portion 105 of sequence x, again m vectors F are determined for each group which may be used for a second estimation, etc., until after portion 106 an m-th estimation may take place.

Also in this case, the above scheme may be repeated and the vectoring may be adapted according to equation (21), or after some time, for example after sequences 100 and 101, a switch may be made to determining the FEXT coefficients for a specific tone based only on intermediate vectors for these tones. For example, the estimation indicated for sequence 100 may be continued for sequence 101, and then the next estimation may be made only after completion of sequence 102 based on F₁ to Fₘ for each tone. In yet other embodiments, the grouping may be changed at one or more points in time. For example, in the embodiment represented by FIG. 10, at some point in time, for example after completion of a sequence like sequence 100, 101 or 102, the grouping of the tones may be changed. For example, the tones may be regrouped such that tones y+m/2−1 to y+m+m/2−2, tones y+m+m/2−1 to y+2m+m/2−2 etc. form a group or, in other words, the tones which in FIG. 10 are at the “center” of a group are now at the border of the group. Other regroupings are also possible, for example the “group borders” shown in FIG. 10 may be shifted by a predetermined number of tones each time a predetermined time has passed, for example such that each tone is at or near the center of a group at some time. This regrouping in an embodiment is made for all communication connections of a vectored group.

In embodiments, information regarding the sequence shift explained above is exchanged between communication devices, for example between communication device 10 and communication devices 16-19 in FIG. 1. For example, if an additional line becomes active, a central office equipment, for example communication device 10 of FIG. 1 or communication device 69 of FIGS. 5 and 6, may inform a downstream end, for example, communication devices 16-19, of a shift to be used.

The embodiments explained with reference to FIGS. 7-10 may be used both in the downstream direction (as for example shown in FIG. 5) and in the upstream direction (as shown for example in FIG. 6). Moreover, while the situation where crosstalk from a plurality of lines in the vectored group to a joining line is to be cancelled has been used as an example, the above embodiments may also be used for cases where crosstalk from a joining line to vectored lines is cancelled. In this case, for example in FIGS. 5 and 6 error values are determined at the lines already in the vectored group and used for adaptation of the vectoring. In still other embodiments, the two cases are handled jointly, i.e. error signals or values from all involved communication connections, both those in the vectored group and those joining, are used for adaptation of the vectoring.

Moreover, the above embodiments, i.e. calculating the FEXT coefficients based on intermediate vectors and the use of shifted sequences for earlier estimation, may not only be used when a communication connection joins a vectored group, but also during a so-called tracking where cross coupling coefficients are adapted or adjusted during data transmission to accommodate changing line conditions.

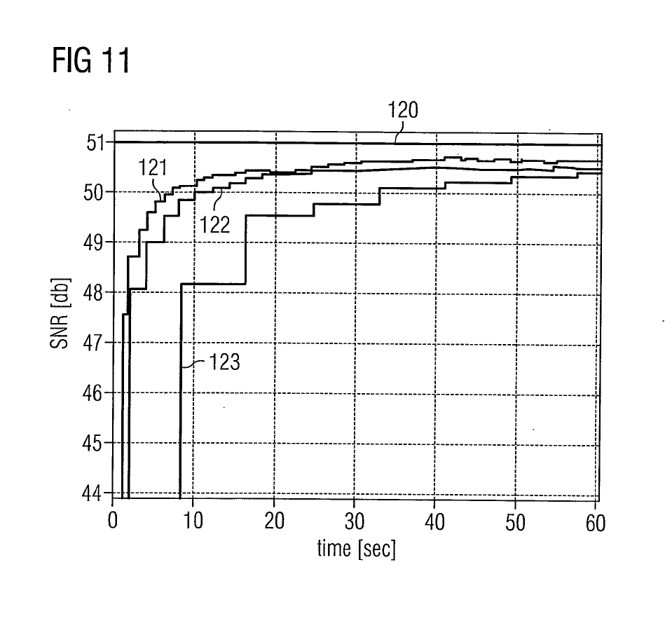

With embodiments like the ones discussed with reference to FIGS. 7-10, a fast adaptation is possible. In this respect, FIG. 11 shows a simulation where the signal to noise ratio for a frequency of 5.2 MHz is shown over time for a simulated system of 99 active lines and a orthogonal sequence length n=128. A curve 120 shows the signal to noise ratio without crosstalk, i.e. the optimum which would be attainable with complete crosstalk cancellation or precompensation. Curve 123 shows the development after the start of the adaptation of the vectoring for a conventional system which does not use groupings of tones, but which determines a vector FEXT each time after a complete training sequence has been transmitted. Curve 121 shows the situation with m=8, i.e. 8 tones per group with shifted sequences (a shift of 16 elements in this case) and curve 122 shows the simulation result for 4 tones per group (a shift of 32 elements). As can be seen, with the grouping of some embodiments of the present invention a faster rise of the signal to noise ratio can be obtained, which in turn for example enables a joining line to become active faster.

It should be noted that the above-described embodiments serve only as examples, and a plurality of modifications or variations are possible without departing from the scope of the present invention. For example, while in FIGS. 9 and 10 with increasing frequency a shift with regular intervals was used, in other embodiments the allocation of shift to the tones in a group may not be sequentially. For example, in an alternate embodiment in FIG. 9 tone 2 may be assigned a shift of 4 elements, tone 3 a shift of 2 elements and tone 4 a shift of 6 elements.

As many variations and alterations are possible as explained above, the scope of the present application is not to be limited by the above-described embodiments, but is intended to be limited only by the appended claims and equivalents thereof.

1-15. (canceled)

16. An apparatus comprising a transmitter configured to transmit data via a plurality of communication channels of a communication connection, the transmitter being further configured to transmit a same sequence for vector training on each of the communication channels, the sequences for at least two of the communication channels being shifted with respect to each other.

17. The apparatus of claim 16, wherein the communication channels are grouped into a plurality of groups of communication channels, and sequences transmitted on the communication channels within a group are shifted with respect to each other.

18. The apparatus of claim 17, wherein the sequences have a length of n elements, each group comprises m communication channels, and sequences for communication channels within a group are shifted by n/m elements with respect to each other.

19. The apparatus of claim 16, further comprising a receiver configured to receive a shift magnitude characterizing a number of sequence elements by which the shifting is affected.

20. The apparatus of claim 16, wherein the transmitter is configured to transmit DSL data via the communication connections, the communication channels correspond to different tones, and the sequences are sequences of pilot symbols.

21. The apparatus of claim 16, comprising at least one further transmitter configured to transmit data via a plurality of further communication channels of at least one further communication connection, wherein the at least one further transmitter is configured to transmit a same sequence for vector training on each of the further communication channels of each of the at least one further communication connection, wherein, for each of the at least one further communication connections, the sequence for at least two further communication channels is shifted with respect to each other, and wherein the communication connection and each of the at least one further communication connection is assigned a different sequence for vector training.

22. The apparatus of claim 21, wherein the sequences assigned to the communication connection and the at least one further communication connection are orthogonal to each other.

23. The apparatus of claim 22, wherein the sequences are based on Walsh-Hadamard sequences.

24. The apparatus of claim 16, wherein the sequence is transmitted to provide vector training for at least one of the group consisting of: reducing crosstalk from a joining communication connection to communication connections of a vectored group; reducing crosstalk from communication connections in a vectored group to a joining communication connection; and reducing crosstalk between communication connections of a vectored group.

25. An apparatus comprising a vectoring device configured to reduce crosstalk between a plurality of communication connections by vectoring and determine crosstalk coupling between the communication connections, each communication connection comprising a plurality of communication channels, the vectoring device being further configured to adapt the vectoring based on a plurality of error values, each error value being indicative of a difference between a transmitted pilot signal and a received pilot signal, the pilot signals being parts of sequences of pilot signals, and the error values being derived from different communication channels and comprising one error value for each element of the sequences.

26. The apparatus of claim 25, wherein the vectoring device is configured to obtain a set of error values for a specific communication channel by interpolation.

27. The apparatus of claim 25, wherein the vectoring device is configured to determine a plurality of intermediate vectors, each intermediate vector being based on different ones of the plurality of error values, and to determine crosstalk couplings based on linear combinations of the intermediate vectors.

28. The apparatus of claim 25, wherein the error values are derived from a communication connection to be added to a vectored group of communication connections.

29. The apparatus of claim 25, further comprising a plurality of transmitters, each transmitter being coupled to one of the communication connections, wherein a different sequence of pilot signals is assigned to each of the communication connections and each of the transmitters is configured to transmit the respective assigned sequence over all communication channels of its assigned communication connections with a shift between at least two sequences assigned to different communication channels of a communication connection.

30. The apparatus of claim 29, further comprising at least one receiver configured to receive the plurality of error signals based on the sequences.

31. The apparatus of claim 25, further comprising a plurality of receivers, each receiver being coupled to one of the plurality of communication connections and configured to receive shifted sequences of pilot signals on each of the communication connections, and wherein the apparatus is configured to determine the plurality of error values based on the sequences.

32. The device of claim 25, wherein the communication connections are DSL communication lines and the communication channels are different tones.

33. A method, comprising:
transmitting a different sequence of pilot signals over each of a plurality of communication connections, each communication connection comprising a plurality of communication channels;
transmitting the respective sequence on each communication channel of a communication connection; and
shifting the sequences for at least two communication channels of a communication connection with respect to each other.

34. The method of claim 33, wherein a same shift magnitude is applied to corresponding communication channels on different communication connections.

35. The method of claim 33, wherein communication channels on each communication connection are grouped, and wherein the transmitting comprises transmitting the sequences on communication channels within a group shifted with respect to each other.

36. The method of claim 35, wherein the sequences have a length of n elements, each of the groups comprises m communication channels, and sequences for communication channels within a group are shifted by n/m elements with respect to each other.

37. The method of claim 35, further comprising regrouping the communication channels.

38. The method of claim 33, further comprising communicating a magnitude of the shift.

39. A method, comprising:
obtaining a plurality of error values based on sequences of pilot signals;
determining intermediate vectors, each intermediate vector being based on different ones of the error values, components of each of the intermediate vectors being linear combinations of crosstalk couplings between different communication connections; and
determining crosstalk coupling between different communication connections based on linear combinations of the intermediate vectors.

40. The method of claim 39, further comprising adapting a vectoring used to reduce crosstalk between the communication connections based on the crosstalk coupling values.
